(19) United States
(12) Patent Application Publication
(10) Pub. No.: US 2016/0046535 A1
(43) Pub. Date: Feb. 18, 2016

(54) USING PHYLLOSILICATE-FE(II)-OXIDIZING SOIL BACTERIA TO IMPROVE FE AND K PLANT NUTRITION

(71) Applicant: Wisconsin Alumni Research Foundation, Madison, WI (US)

(72) Inventors: Evgenya Shelobolina, Fitchburg, WI (US); Eric Roden, Middleton, WI (US); Jason Benzine, Columbus, WI (US); Mai Yia Xiong, Madison, WI (US)

(21) Appl. No.: 14/924,397

(22) Filed: Oct. 27, 2015

Related U.S. Application Data
(63) Continuation of application No. 14/209,509, filed on Mar. 13, 2014, now abandoned.
(60) Provisional application No. 61/781,582, filed on Mar. 14, 2013.

(51) Int. Cl. C05F 11/08

(52) U.S. Cl. CPC C05F 11/08

(57) ABSTRACT

Methods of increasing the amount of iron (Fe) and potassium (K) available in soil to plants residing in the soil. A composition comprising at least one microorganism capable of oxidizing Fe(II) bound in at least one phyllosilicate and releasing Fe and K from the at least one phyllosilicate to increase availability of Fe and K to plants in soil treated with the composition relative to plants in untreated soil. Compositions and microorganisms capable of oxidizing Fe(II) and K are disclosed.

### CROSS-REFERENCE TO RELATED APPLICATIONS

This application is a continuation of U.S. application Ser. No. 14/209,509, filed Mar. 13, 2014, which claims the benefit of U.S. Provisional Patent Application No. 61/781,582, filed Mar. 14, 2013, each of which is incorporated herein by reference as if set forth in its entirety.

### STATEMENT REGARDING FEDERALLY SPONSORED RESEARCH OR DEVELOPMENT

This invention was made with government support under DE-AC05-76RL01830 and DE-SC0001180 awarded by the U.S. Department of Energy. The government has certain rights in the invention.

### BACKGROUND

Potassium (K) is an essential nutrient for plant growth. In soil, K is present at levels of 0.04-3%, however a significant portion of K in soil is unavailable to plants. Ninety-eight percent of soil K is bound within the structure of phyllosilicates, layer silicate minerals commonly found in soil silt- and clay fractions. 2% of K exists in solution and exchangeable phases, which are readily available to plants (Sparks, D. L., and P. M. Huang (1985), Physical chemistry of soil potassium, p. 201-276. In R. D. Munson (ed.), Potassium in agriculture. American Society of Agronomy, Madison, Wis.). Potassium deficiency in plants is common due to low soil K availability. The least expensive and most extensively used K-containing fertilizer is KCl (also referred to as “potash” or “muriate of potash”), however KCl has a high salt index and thus should to be applied with caution (Schulte, E. E., and K. A. Kelling. A2521. Soil and Applied Potassium. Cooperative Extension Publications, UW-Madison, Wis.).

Weathering of primary phyllosilicate minerals, such as mica (in the form of biotite or muscovite) and feldspar, and the oxidation of Fe(II) in secondary phyllosilicates, such as smectite-illite, are potential Fe and K sources in soils. Observations of natural biotite weathering suggest that oxidation of Fe(II) contained in biotite should result in a corresponding decrease in Fe and K levels (Scott, A. D., and J. Amonette (1988), Role of iron in mica weathering, p. 537-623. In B. A. G. J. W. Stucki, U. Schwertmann (ed.), Iron in soils and Clay Minerals. D. Reidel Publishing Company). The expulsion of Fe and K from the mineral structure is caused by the positive charge excess in the octahedral sheet when structural Fe(II) is oxidized to Fe(III). Release of Fe and K in conjunction with structural Fe(II) oxidation has also been observed in secondary phyllosilicates (Stucki, J. (2011), A review of the effects of iron redox cycles on smectite properties. Comptes Rendus Geoscience 343:199-209). Despite the fact that weathering liberates K abiotically, the process is slow and cannot supply plants with the biologically required concentrations of this element. Thus, K contained within micas, feldspar, and clay minerals is considered unavailable to plants (Schulte, E. E. A3554. Soil and Applied Iron. Cooperative Extension Publications, UW-Madison, Wis.; Schulte, E. E., and K. A. Kelling A2521. Soil and Applied Potassium. Cooperative Extension Publications, UW-Madison, Wis.).

Multiple Fe(III) hydroxide reducing and soluble Fe(II)-oxidizing organisms are available as model microbial agents (Lovley et al., 2004; Weber et al., 2006; Emerson et al., 2010; Schmidt et al., 2010; Konhauser et al., 2011). Much less is known about microorganisms involved in phyllosilicate-Fe redox cycling. When 10 Fe(III)-reducing organisms [enriched and isolated with Fe(III) hydroxide as the sole electron acceptor] were tested for growth on a model ferruginous smectite, only eight could reduce structural Fe(III) in the smectite (Kashefi et al., 2008), suggesting that phyllosilicate-Fe(III)-reducing and Fe(III) (hydr)oxide-reducing microbial populations may not always overlap. Even less is known about organisms capable of oxidizing structural Fe(II) in smectite. The only culture known to catalyze this reaction is a strain of Desulfitobacterium hafniense (formerly D. frappieri) isolated from a subsurface smectite bedding, which is capable of NO⁻₃-dependent structural Fe(II) oxidation (Shelobolina et al., 2003).

There has arisen in the art a need for methods to enhance the release of K and Fe in soils in forms suitable for use by plants.

### BRIEF SUMMARY

The invention relates generally to soil microorganisms that oxidize Fe(II) contained in phyllosilicates, particularly in primary phyllosilicates, thus facilitating Fe and K release from mica minerals in soil, and more particularly to methods of utilizing these microorganisms to improve potassium bioavailability to plants.

In a first aspect, the present invention is summarized as an isolated microorganism that oxidizes Fe(II) in a primary phyllosilicate mineral matter in soil such that potassium and iron are released from the mineral matter and become available to plants in the soil.

In some embodiments of the first aspect, the microorganism is a cultured Bradyrhizobium strain, a Cupriavidus necator strain, a Ralstonia solanacearum strain, a Dechloromonas agitata strain, or a Nocardioides strain.

In some further embodiments of the first aspect, the microorganism is selected from the group consisting of the strains identified in the following table. The degree of similarity of the 16S rRNA gene sequence (identified where available by GenBank accession number) to other bacteria is noted. Certain isolates listed below were obtained from a second sediment site.

| | | | Identification |
|---|---|---|---|
| | | | (closest cultured |
| Microbial | | GenBank | bacterium, |
| culture | Strain | accession# | % identity) |
| Bradyrhizobium | wssl4 | JQ655459 | B. Haoningense |
| sp | | | 2281^{T}, 99.6% |
| | | | B. japonicum |
| | | | USDA 6^{T}, 99.4% |
| Bradyrhizobium | 22 | KF800709 | B. liaoningense |
| sp | | | 2281^{T}, 99.0% |
| | | | B. japonicum |
| | | | USDA 6^{T}, 99.0% |
| Bradyrhizobium | bis5 | KF800707 | B. Haoningense |
| sp | | | 2281^{T}, 99.5% |
| | | | B. japonicum |
| | | | USDA 6^{T}, 99.4% |
| Bradyrhizobium | in8p8 | KF800708 | B. Haoningense |
| sp | | | 2281^{T}, 99.4% |
| | | | B. japonicum |
| | | | USDA 6^{T}, 99.4% |
| Cupriavidus | ss1-6-6 | JQ655461 | C. necator |
| necator | | | ATCC 43291^{T}, 99.5% |
| | | | “R. eutropha” |
| | | | H16, 99.6% |
| Cupriavidus | A5 | KF800713 | C. necator |
| necator | | | ATCC 43291^{T}, 98.6% |
| | | | “R. eutropha” |
| | | | H16, 98.4% |
| Ralstonia | in4ss52 | JQ655458 | R. solanacearum |
| solanacearum | | | LMG 2299^{T}, 98.7% |
| Dechloromonas | dis5 | KF800710 | D. agitata |
| agitata | | | CKB^{T}, 99.6% |
| Nocardioides | in31 | KF800711 | N. pyridinolyticus |
| sp | | | OS4^{T}, 97.9% |

In a second aspect, the present invention is summarized as methods for isolating, culturing, and storing the microorganisms and cultures of the invention.

In a third aspect, the present invention is summarized as methods for formulating the isolated microorganisms and cultures of the invention as inoculants for use as fertilizers of soil that contains primary phyllosilicates.

In a fourth aspect, the present invention is summarized as methods for fertilizing soil that contains primary phyllosilicates.

These and other features, objects, and advantages of the present invention will become better understood from the description that follows. In the description, reference is made to the accompanying drawings, which form a part hereof and in which there is shown by way of illustration, not limitation, embodiments of the invention. The description of preferred embodiments is not intended to limit the invention to cover all modifications, equivalents and alternatives. Reference should therefore be made to the claims recited herein for interpreting the scope of the invention.

### BRIEF DESCRIPTION OF THE DRAWINGS

The present invention will be better understood and features, aspects and advantages other than those set forth above will become apparent when consideration is given to the following detailed description thereof. Such detailed description makes reference to the following drawings, wherein:

FIG. 1 depicts photograph of soil collected from the sample site in the vicinity of the water table in July 2007. Reduced (gray) and oxidized (bright yellow-brown) regions are indicative of redoximorphic conditions.

FIGS. 2A-2E illustrate the soil composition at the sample site. (A) depth distribution of dissolved H₂; (B) Organic Carbon; and (C-E) Fe phases, including (C) citrate-bicarbonate-dithionite (CDB) extractable Fe, (D) hydrofluoric acid (HF) extractable Fe and (E) Fe(II)/Fe total in sample soil, July 2007. The schematic on the left shows relative depth of root zone and terminal electron accepting processes (TEAPs): brown for mixed metabolism, green for Fe(III)-reducing zone, and blue for methanogenic zone.

FIG. 3 depicts a TEM image of sample silt size fraction illustrating flakes of illite-smectite (I/S), quartz (Qz), and potassium feldspar (KF) grains.

FIGS. 4A-4D depict mineralogy of sample site clay size fraction. (A) TEM image illustrating flakes of smectite-dominated clay minerals (I/S), quartz (Qz), potassium feldspar (KF), plagioclase, and titania (TiO₂) grains. (B-C) illustrate HRTEM image and selected area diffraction pattern taken from the area indicated by the large arrow in panel A, showing the curled edge of a clay aggregate with lattice fringes corresponding to (001) smectite with about 10-Å layer spacing; the size of this spacing was likely reduced in the vacuum of the TEM. (D) illustrates EDAX results for an I/S aggregate. A small amount of potassium was detected, indicating that the smectite contained an illite component.

FIG. 5 depicts an XRD analyses of clay size fraction from sample soil showing illite-smectite (I/S) as dominant mineral. Small amounts of illite (I), kaolinite (Ka), and quartz (Qz) also exist. The 13.6 Å [I/S (001)] peak in the untreated sample expanded to 15.2 Å by ethylene glycol treatment, and collapsed to 9.9 Å by heat treatment. The 7.2 Å [kaolinite (001)] and 3.6 Å [kaolinite (002)] peaks in the untreated sample disappeared by heating at 550° C.

FIG. 6 depicts Fe(II) oxidation in Bancroft biotite (measured after 1 hour, 0.5N HCl extraction) by culture b3-8 (also designated as #22). This culture served as a source for isolation of Bradyrhizobium sp strain 22. The measurements are from duplicate cultures.

FIG. 7 depicts colonies of Fe(II)-oxidizing microorganisms cultured on aerobic medium with Bancroft biotite provided as the only electron donor.

FIGS. 8A-8C depict reduction of native Fe(III) phyllosilicate in sample soil (clay size fraction) by G. toluenoxydans strain sa2, followed by oxidation of reduced phyllosilicate by the three Fe(II)-oxidizing isolates with NO₃⁻ as the electron acceptor.

FIG. 9 depicts chemical oxidation of microbially-reduced sample soil (clay size fraction) by nitrite.

While the present invention is susceptible to various modifications and alternative forms, exemplary embodiments thereof are shown by way of example in the drawings and are herein described in detail. It should be understood, however, that the description of exemplary embodiments is not intended to limit the invention to the particular forms disclosed, but on the contrary, the intention is to cover all modifications, equivalents and alternatives falling within the spirit and scope of the invention as defined by the appended claims.

### DESCRIPTION OF EXEMPLARY EMBODIMENTS

Exhibits A and B, published papers describing various aspects of the subject technology, are attached hereto and incorporated herein by reference as if set forth in their entirety. These Exhibits expand upon the disclosure presented herein.

The present invention relates to the inventors' observation that structural Fe(II) in biotite (a Fe(II)-bearing mica) can be utilized as an electron donor for energy metabolism by certain microorganisms (neutrophilic lithotrophs), and thereby can be oxidized. Following that finding, the inventors enriched for and isolated microorganisms capable of oxidizing structural Fe(II) from soil minerals (i.e., biotite and smectite). The isolates obtained were common soil bacteria, including strains of Bradyrhizobium japonicum, Cupriavidus necator, Ralstonia solanacearum, Dechloromonas agitate, and Nocardioides sp.

In one aspect of the present invention, an isolated bacterial strain oxidizes Fe(II) in a primary phyllosilicate in soil such that Fe and K are released to levels that support growth of a plant in the soil, the strain being selected from the group consisting of the strains noted in the Summary of the Invention. It is further contemplated herein that strains of the invention can be genetically altered using techniques known to one skilled in the art to impart other desirable attributes to, or remove undesirable attributes from, the strains.

The strains can be provided in formulations with a carrier and optionally with a stabilizer. Suitable carriers can include pasteurized peat and peat-like materials. A suspension of the microbial culture is mixed with a peat in a fixed ratio. Cells are well preserved when mixed with such a material. Other carriers and stabilizers for rhizobial inoculants are described in Xavier, I. J., et al., Development of Rhizobial Inoculant Formulations, Crop Management doi:10.1094/CM-2004-0301-06-RV (published Mar. 1, 2004), which is available on a web site maintained by Plant Management Network.

The present invention also relates to the inventors' prediction that Fe(II)-oxidizing microorganisms can be used to improve K and Fe nutrition in plants. Fertilizers and soil conditioners represent significant and rising costs to farmers. The per ton price of KCl in 2011 was more than double that of 2007. Fertilizer prices reflect a major increase in demand for fertilizer due to expanded crop, mainly corn, acreage, as well as tight supplies. Economic sources for K are sedimentary salt beds, salt lakes, and natural brines. The most common K mineral is KCl (sylvite), which is abundant in commercial deposits. The U.S. Geological Survey estimates global reserves of K₂O total about 18 billion tons, of which 8.3 billon tons are considered commercially exploitable (2011. Mineral Commodities Summary. USGS). The fertilizer industry utilizes about 93% of the world's commercially produced potash. World supply/demand balance is considered very tight and is expected to remain so for the next few years.

Use of Fe(II)-oxidizing bacteria as a fertilizer in combination with naturally-occurring primary phyllosilicate sources of K as an alternative to KCl has the potential to overcome traditional K fertilizer shortage and high price. Natural phyllosilicates of soil can provide long term K nutrition for plants. If 1% of the 2 million lbs of soil per acre-furrow slice is mica, then there would be 20,000 lbs of mica per acre. Mica contains about 9% K₂O, equal to 7.5% K. Therefore there is 1500 lb of phyllosilicate K in the acre of soil. Thus soil containing 1% mica that can be gradually weathered by Fe(II)-oxidizing organisms can provide K for 37 years of corn and 20 years of soybean cultivation. Unlocking the potential of the natural phyllosilicates of soil as K source also presents a solution to the “high salinity index” of KCl. Under intensive agricultural practices, increased application of fertilizers leads to gradual soil degradation, reduction in soil fertility, and the salinization of soil.

Liquid fertilizers containing Fe(II)-oxidizing microorganisms could access the potential of mica and clay minerals to serve as sources for Fe and K nutrition for plants. In another aspect of the invention, a method of increasing the amount of iron (Fe) and potassium (K) available in soil to plants residing in the soil is provided. The method involves applying to soil a composition comprising at least one microorganism capable of oxidizing Fe(II) bound in at least one primary phyllosilicate and releasing Fe and K from the at least one phyllosilicate to increase availability of Fe and K to plants in soil treated with the composition relative to plants in untreated soil. Microorganisms appropriate for use in the methods include, but are not limited to the strains mentioned in the Summary of the Invention. Each of these microorganisms has the capacity to oxidize Fe(II) and release Fe and K from phyllosilicates.

It is contemplated that such fertilizer compositions can be produced and applied to soil using methods similar to those appropriate for fertilizers containing N₂-fixing bacteria, such as Rhizobia. Rhizobia-related organisms such as, but not limited to, Bradyrhizobium have good prospect for commercial application as fertilizers because there is an established, long-term practice of using them to improve nitrogen plant nutrition. It is contemplated herein that the disclosed isolates, genetically engineered isolates thereof, and compositions can facilitate nitrogen-fixation in addition to enhancing Fe and K availability to plants. In such an instance, a single species or single composition could be used to improve soil levels of available K, Fe and N.

One of skill in the art is aware of methods to identify optimal quantities of fertilizer components to achieve desired effects on plants.

Unless defined otherwise, all technical and scientific terms used herein have the same meaning as commonly understood by one of ordinary skill in the art to which the invention pertains. Although any methods and materials similar to or equivalent to those described herein can be used in the practice or testing of the present invention, the preferred methods and materials are described herein.

In describing the embodiments and claiming the invention, the following terminology will be used in accordance with the definitions set out below.

As used herein, “about” means within 5% of a stated concentration range or within 5% of a stated time frame.

As used herein, “available” or “available to plants” means in a form that plants can consume and utilize.

As used herein, “effective amount” means an amount of an agent sufficient to evoke a specified chemical and or biological effect according to the present invention.

As used herein, “release” or “release from a phyllosilicate” means mobilized.

The invention will be more fully understood upon consideration of the following non-limiting Examples. All papers and patents mentioned herein are hereby incorporated by reference as if set forth in their entirety.

### EXAMPLES

### Example 1

Materials and Methods

Study site and sample collection. Soil and groundwater samples were collected from Shovelers Sink site located in the Cross Plains, Wis. unit of the Ice Age National Scientific Reserve, about 50 meters from Mineral Point Road and 17 m from the pond. Soils were collected (January 2007, July 2007, June 2008, and September 2009) with a stainless steel coring device. Fluid from below the water table was collected in 50-mL plastic tubes. Core sections were placed in sterile sample collection plastic bags and immediately delivered to the laboratory. All core sections were placed into an anaerobic chamber filled with N₂:H₂ mix (95:5), homogenized, and dispensed into serum bottles or pressure tubes for immediate experimentation, or into large Pyrex bottles with thick rubber stoppers for storage and/or later use. After removal from the anaerobic chamber, all bottles were flushed with O₂-free N₂ (passed over reduced, hot copper filings) to remove H₂ from the headspace. Soil water was filtered through a 0.2 μm syringe filter and frozen prior to analysis by ion chromatography.

Separation and analysis of grain size fractions. Soils were size fractionated by wet-sieving and centrifugation (Jackson, 1969; Gee & Bauder, 1986). Wet-sieving was performed in the anaerobic chamber using water made anoxic by bubbling with N₂. 160 ml pressure bottles containing 100 ml water each were bubbled for 1 hour. No gravel size particles (>2 mm) were found in the materials. Sand (50 μm-2 mm) size materials were removed by sieving (USA Standard Testing Sieves, VWR Scientific). The remaining silt (2 μm-50 μm) and clay (<2 μm) grain size fractions were separated by centrifugation in sealed plastic bottles under N₂. The settling time for the clay size fraction was calculated for a particle density of 2.6 g/cm³ using Stokes' Law. A small portion of each size fraction was used to determine the dry weight per unit volume of soil suspension. These subsamples were dried at 105° C. and wet/dry sample weight factors were calculated from weight differences before and after drying.

Total Fe(II) and Fe(III) in the size fractions was determined by the hydrofluoric acid (HF) extraction followed by the 1,10-Phenanthroline assay as described by Stucki (Stucki, 1981) and modified by Komadel and Stucki (Komadel and Stucki, 1988). Fe(III) oxyhydroxide contents were determined by citrate-bicarbonate-dithionite (CDB) extraction (Mehra and Jackson, 1980) and ferrozine analysis (Stookey, 1970). All Fe measurements were performed in triplicate. Organic carbon was measured with a Leco CHN analyzer at the UW Madison Soil and Plant Analysis Laboratory.

Determination of steady state H₂ concentrations. To determine steady-state dissolved H₂ concentration in the porewater within representative soil samples, about 30 g of each sample were placed into 60 mL serum bottles under an N₂ atmosphere. H₂ concentration in the headspace was monitored over time with a reduction gas analyzer (ta3000 Gas Analyzer, Trace Analytical, Ametek) until stability was reached.

Transmission electron microscopy. Transition electron microscopy (TEM) analyses were carried out using a FEI Titan 80-200 aberration corrected scanning/transmission electron microscope associated with an EDAX AMETEK high resolution energy-dispersive X-ray spectroscopy (EDS) detector and Gatan image filtering system, and operated at 200 kV. The samples were mixed with distilled water and ultrasonicated for ˜3 min. A drop of the resulting suspension was placed on a lacey-carbon coated Cu grid and air-dried.

X-ray diffraction. X-ray diffraction (XRD) analyses were done using a Scintag Pad V Diffractometer with CuKa radiation. The instrument used an accelerating voltage of 45 kV, a current of 40 mA, a 2-mm divergence slit, 4-mm incident scatter slit, 1-mm diffracted beam scatter slit, and 0.5-mm receiving slit. Scan parameters used were a step size of 0.02° and a dwelling time of 2 sec. Oriented aggregate mounts were prepared by pasting clay-DI water suspension on glass slides and air drying. A drop of ethylene glycol was added directly to the surface of the oriented clay mount with a glass rod for ethylene glycol treatment. Oriented aggregate mounts were heated at 550° C. for three hours in the furnace for heat treatment.

Most probable number analysis. Microorganisms were enumerated by the Most Probable Number (MPN) method (Woomer, 1994). Strict anaerobic laboratory technique (Miller and Wolin, 1974) was used to quantify anaerobic Fe(III)-reducing bacteria. An anaerobic basal bicarbonate-buffered freshwater (FW) medium (Lovley and Phillips, 1988) was dispensed into 27 mL anaerobic pressure tubes (Bellco Glass, Inc.) under N₂/CO₂ (80%:20%). The tubes were capped with butyl rubber stoppers and sterilized by autoclaving. The medium for Fe(III)-reducing bacteria contained either 100 mM hydrous ferric oxide (HFO) or 0.8 weight % of the Fe(III)-bearing smectite NAu-2 [M^{0.72}(Si_{7.55}Al_{0.45})Fe_{3.83}Mg_{0.05})O₂₀(OH)₄ where M is the interlayer cation] (Keeling et al., 2000) as a terminal electron acceptor, H₂ (3 ml filtered H₂ was added to the headspace) and acetate (10 mM) as the combined electron donor, and 1.3 mM FeCl₂ as a reducing agent. The medium for Fe(II)-oxidizing bacteria contained O₂ as the terminal electron acceptor (3 ml filtered air added to the headspace) and 1.1% Bancroft (Ward Scientific) biotite [(K_{0.980}, Na_{0.025})(Fe²⁺_{0.996}, Fe³⁺_{0.222}Mg_{1.663}, Ti_{0.117}) (Si_{3.048}, Al_{0.812}, Ti_{0.140})O₁₀(OH_{1.02}, F_{0.98})] as a source of structural Fe(II). Aerobic heterotrophic bacteria were enumerated in medium containing (g/l) PIPES (piperazine-N,N′-bis-2-ethanesulfonic acid) buffer (3.0), NH₄Cl (0.25), NaH₂PO₄.H₂O (0.06), KCl (0.1), yeast extract (0.5), and acetate (0.41).

Isolation of Fe(III)-reducing organisms. Smectite-containing MPN cultures were diluted in agarized medium containing 20 mM fumarate and 20 mM acetate with a roll-tube method (Hungate, 1968). An inoculum (1 ml) from the 10-fold serial dilutions of the enrichment culture in a liquid FW medium was added to 27 ml pressure tubes containing 7 ml melted medium. The contents were mixed gently and the pressure tubes were rolled with a tube spinner. The roll-tubes were incubated vertically at room temperature. Individual colonies were transferred to the pressure tubes with 2 ml liquid FW medium containing 0.8% NAu-2 smectite as the electron acceptor and 10 mM acetate as the electron donor.

Isolation of Fe(II)-oxidizing organisms. Freshly collected samples and highest positive MPN dilution cultures were serially diluted in biotite/O₂-containing roll-tubes. Orange- and red-colored individual colonies that formed were transferred to the pressure tubes with 2 ml liquid FW medium containing 1.1% biotite and 3 ml filtered air. Biotite oxidizing cultures were serially diluted and plated on aerobic heterotrophic medium using 1.5% agar as the solidifying agent.

Biotite oxidizing cultures were tested for their ability to grow via microaerophilic FeCl₂ oxidation. The cultures were grown on a heterotrophic low-organic medium (0.01% yeast extract and 1 mM acetate, with 3 ml of filtered air in the headspace), and then transferred (5% vol/vol inoculum) to anoxic FW medium, to which 1.3 mM FeCl₂ and 1 ml filtered air were added via syringe and needle every other day. After 12 days of cultivation, cell numbers were determined. The aliquots of the culture were fixed with glutaraldehyde. The fixed culture was reacted with ammonium oxalate (28 g/L ammonium oxalate and 15 g/L oxalic acid) in the presence of about 1 mM FeCl₂ to dissolve Fe(III) hydroxides. Cells were counted by acridine orange staining and epifluorescence microscopy (Hobbie et al., 1977).

Molecular biological methods. The 16S rRNA gene sequences of the isolates and enrichment cultures were obtained using standard methodologies as previously described (Shelobolina et al., 2007). 16S rRNA genes were amplified using GM3 and GM4 universal bacteria primer set (Muyzer et al., 1995). For enrichment cultures, 16S rRNA genes were cloned using the pGEM-T vector (Promega). The 16S rRNA gene fragments were compared to the GenBank nucleotide database using BLASTN and BLASTX algorithms (Altschul et al., 1990).

Fe cycling experiment. An iron cycling experiment was performed in FW medium supplemented with natural Shovelers Sink clay. The clay suspension was bubbled with air for one day to oxidize structural Fe(II), after which the clay was dried and mixed with FW medium prior to bubbling with N₂:CO₂ mix and sterilization. A small amount of acetate (0.25 mM) was provided as a limited source of electron donor. Eighteen culture tubes were inoculated with G. uraniireducens strain sa2 isolated from Shovelers Sink soil, and 3 tubes served as abiotic controls. Fe(III) reduction was allowed to proceed for 10 days. Five mM NO₃⁻ was then added to 12 tubes, and of these tubes 9 were inoculated with Fe(II)-oxidizing isolates with 3 uninoculated tubes serving as controls. No nitrate or Fe(II)-oxidizing culture were added to 3 tubes in which Fe(III) reduction was allowed to proceed for the rest of the experiment. To evaluate the reaction of structural Fe(II) oxidation with nitrite, 3 remaining tubes with reduced Shovelers Sink clay were reacted with about 2.0 mM nitrite.

Concentrations of 0.5 N HCl-extractable Fe(II), NO₃⁻, and NO₂⁻ were monitored over time. One ml of the culture was centrifuged in the anaerobic chamber at 14K rpm for 5 minutes. The supernatant was collected for NO₃⁻/NO₂⁻ and dissolved Fe analysis. Samples for Fe analysis were acidified with HCl. The remaining solids were mixed with 0.5 N HCl and extracted for 24 hours. Fe(II) in the HCl extracts was quantified using the ferrozine assay as previously described (Lovley and Phillips, 1986). Preliminary studies demonstrated that a 24 hour 0.5 N HCl extraction released the same amount of Fe(II) from Shovelers Sink clay as HF extraction (Stucki, 1981). Note that this equivalence applies only to Fe(II), as only a small portion of structural Fe(III) is extracted by 0.5 N HCl (Shelobolina et al., 2004). NO₃⁻ and NO₂ concentrations were measured with a Dionex DX-100 ion chromatograph equipped with a AS4-SC IonPac column. Dissolved Fe concentrations were determined by inductively coupled plasma-optical emission spectroscopy (ICP-OES).

The Fe(II)-oxidizing isolates' ability to increase K bioavailability from primary phyllosilicates will be tested on corn and soybean grown in greenhouses as a model for use of the invention in other plants, including but not limited to other crop plants, trees, and shrubs. Corn and soybean are examples two major crops in the United States and Wisconsin; in 2011, 4.15 million acres of corn and 1.66 million acres of soybean were planted in Wisconsin, and 92.3 million acres of corn and 75.2 million acres of soybean were planted in the United States Battaglia, 2012. Sand supplemented with P, Mg, Zn, Mo, Fe and N fertilizers will serve as the growth medium (Somasegaran and Hoben, 1994). Potassium will be added to some samples in its native form, silt and clay sized fractions, in the presence or absence of Fe(II)-oxidizing bacterial cultures. Fine-sized mineral fractions will be treated with H₂O₂ to remove excess organic matter. In a parallel experiment, KCl fertilizer will be applied at four different levels (50, 100, 200 and 400 mg per 1.5 kg pot) to serve as a positive control and to provide a basis for comparison. Corn and soybeans will be grown in the greenhouse for 6-8 weeks, and afterward the plants will be harvested. The above-ground dry matter will be collected and percentages of N, P and K will be measured. This will allow us to calculate the uptake of K from the soil in response to the various treatments.

### Example 2

### Biogeochemistry and Soil Mineralogy of Sample Site

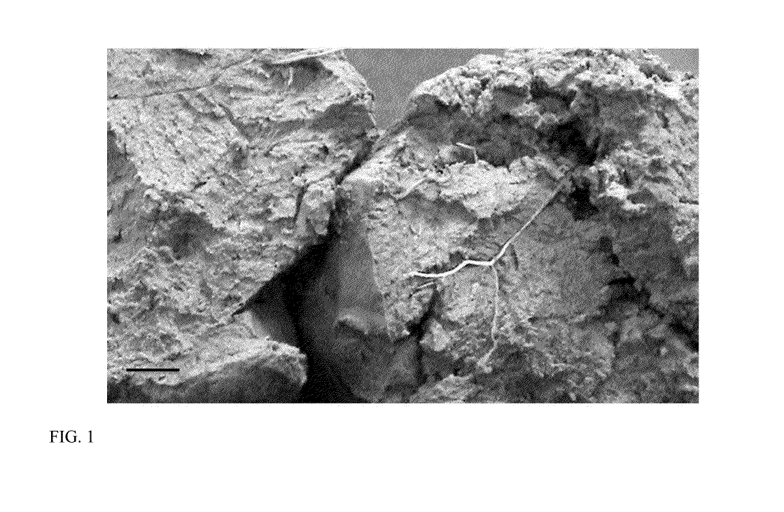

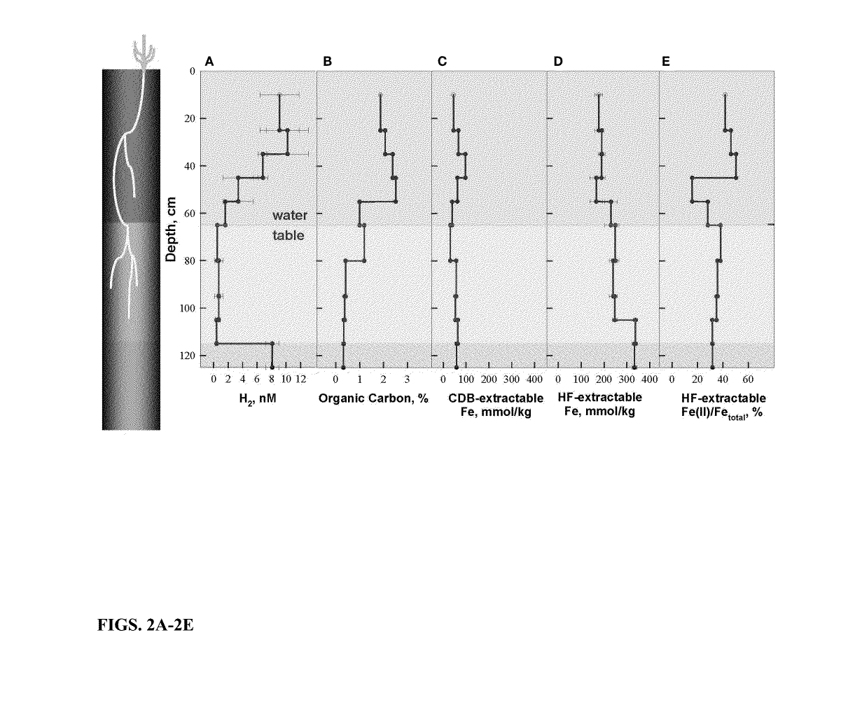

The soil at Shovelers Sink represents a redoximorphic silt loam interspersed with RCG roots down to the depth of 1 m (FIG. 1). The depth of the water table ranged from 60-80 cm. Soils collected in July 2007 were characterized in detail, at which time the water table was located at about 65 cm depth (FIG. 2).

Organic carbon concentrations were highest within the main root zone above 55 cm (1.7-2.5%), intermediate in the vicinity of the water table (1.0-1.2%), and lowest below 80 cm (0.32-0.41%) where few, if any, RCG roots were present (FIG. 2B). Total HF-extractable iron (FIG. 2C) concentrations ranged between 196 and 333 mmol/kg and showed a trend opposite of that for organic carbon, with Fe concentrations being lowest (166-190 mmol/kg) above a depth of 55 cm, intermediate from the water table down to 105 cm (230-249 mmol/kg), and highest below 105 cm (333-337 mmol/kg). The fraction of total Fe present as Fe(II) was highly variable above water table (16-50%) and gradually decreased from 38 to 32% below water table (FIG. 2D).

The spatial segregation of terminal electron accepting processes in Shovelers Sink soil was assessed by measuring steady state concentration of dissolved H₂ in incubated soil samples from different depths, according to published criteria (Lovley et al., 1994) (Lovley and Goodwin, 1988) and as described in a previous study of clay-rich subsurface sediments (Shelobolina et al., 2004) (FIG. 2A). Three TEAP zones could be distinguished: a mixed metabolism zone above water table (0-65 cm depth) characterized by a range of H₂ concentrations from 1.6 to 10.2 nM; a dissimilatory Fe(III)-reducing zone between 65 and 115 cm characterized by H₂ concentrations of 0.4-0.7 nM; and a methanogenic zone below 115 cm with steady state H₂ concentration of 8.1±0.9 nM.

Shovelers Sink is a depression in which water balance is maintained through direct precipitation and runoff from the surrounding landscape. Runoff from nearby farms and households could serve as an additional source of both organic carbon and electron acceptors, e.g. NO₃⁻, to the system. However, no NO₃⁻ was detected in fluid from below the water table on any of the sampling events. These results suggest that the localized zones of oxidation observed in the soil (see FIG. 1) are driven by release of O₂ from RGC roots, as is well-known for a variety of plants that proliferate in water-logged soils (Armstrong, 1978). The observed redoximorphic features (FIG. 1) and porewater steady state H₂ concentrations (FIG. 2A) suggest ongoing Fe redox cycling at two scales: (1) at the cm-to-dm scale within the transition from saturated/anoxic to unsaturated/partially oxic conditions in the vicinity of the water table; and (2) at the microscale around RCG roots both above and below water table. Soil from the vicinity of the water table (about 65 depth in July 2007) was chosen to study microbial Fe redox cycling as it is likely contained both Fe(III)-reducing and Fe(II)-oxidizing microorganisms.

Soil collected from the vicinity of the water table in July 2007 was used to study the abundance and mineralogy of Fe in different grain size fractions. The contribution of silt and clay size materials to total dry weight differed dramatically from their contributions to total HF extractable iron [Fe(II)+Fe(III)] content (Table 1). Although the silt size fraction dominated Shovelers Sink soil by weight (83% of total dry weight), it contributed only 26% total HF-extractable iron. In contrast, the clay-size fraction, which accounted only for 16% of the dry weight of soil, contributed 74% of the total HF-extractable iron. These results demonstrate that the majority of the Fe content of Shovelers Sink soil is contained within the clay size fraction.

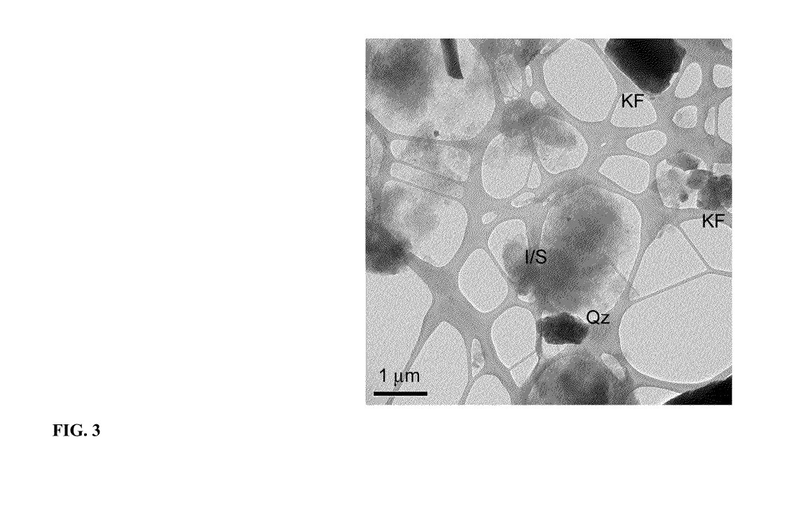

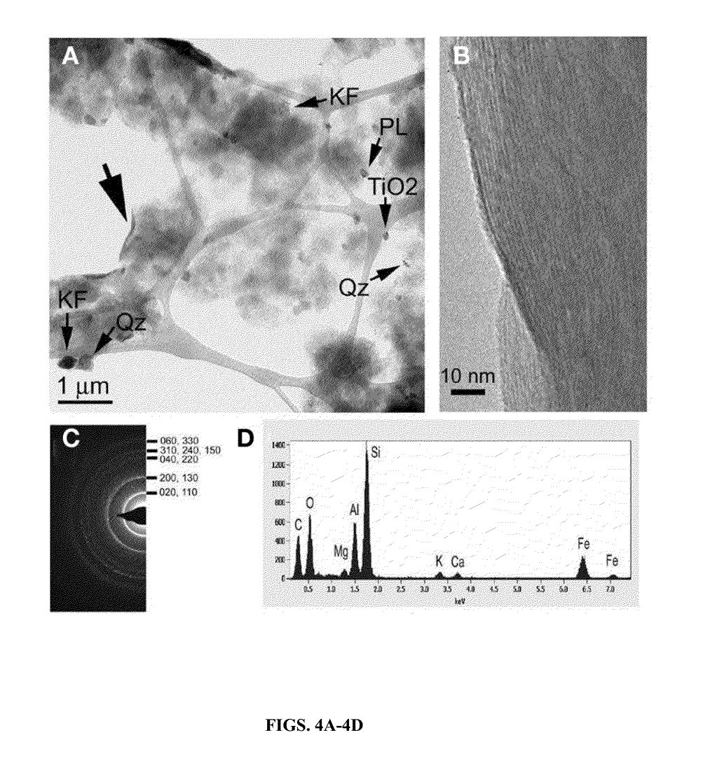

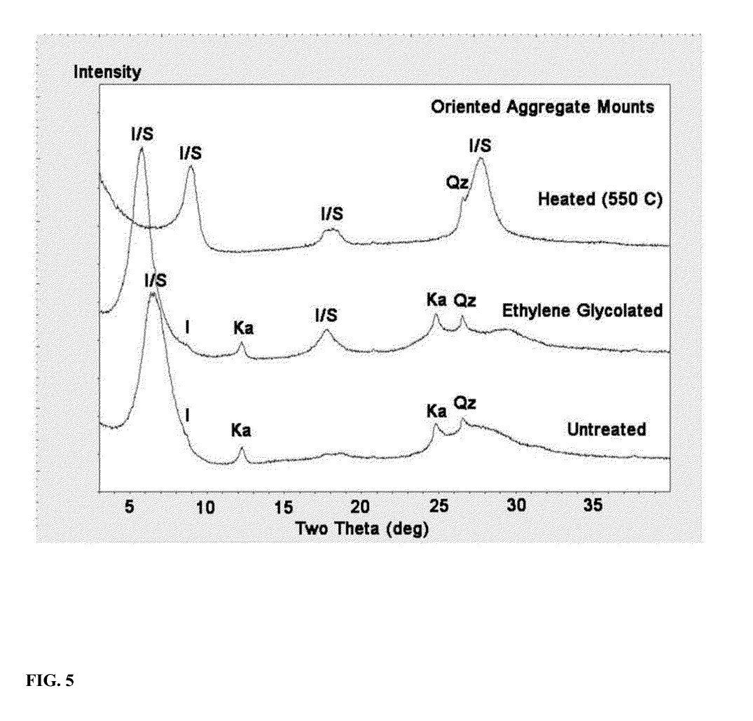

The mineralogy of silt and clay size fractions was characterized by conventional TEM, high resolution TEM (HRTEM) and XRD (FIGS. 3-5). The following mineral phases were identified (by TEM) in the silt size fraction: potassium feldspar, plagioclase, quartz, and mixed layered illite-smectite aggregates (FIG. 3). Based on TEM and XRD analyses, the dominant mineral in the clay size fraction was illite-smectite mixed layers (FIGS. 4 and 5). Clay size materials also contained kaolinite and illite as minor components. No Fe(III) hydroxides were detected in either the silt or clay size fractions during TEM observations. These results are consistent with CDB extractions, which showed that the abundance of Fe(III) oxides was about less than 5% of total HF-extractable Fe in the bulk soil (FIG. 2) and less than 2.5% in the clay size fraction (Table 1). In summary, gravimetric, chemical, and mineralogical analyses collectively suggest that mixed layer illite-smectite is the geochemically dominant Fe-containing phase in Shovelers Sink soil.

TABLE 1
Characterization of silt and clay size
fractions of Shovelers Sink soil.

| | Size Fraction | |
|---|---|---|
| Parameter | Clay | Silt |
| % dry weight^{a} | 16 | 83 |
| Dominant minerals^{b} | illite-smectite | potassium feldspar, |
| | mixed layers, | plagioclase, quartz, |
| | kaolinite, quartz, | and illite-smectite |
| | illite, and TiO₂ | aggregates |
| HF-extractable Fe, mmol/kg | 1360.5 ± 10.7 | 95.7 ± 3.3 |
| % total Fe^{c} | 74 | 26 |
| CDB-extractable Fe, mmol/kg | 32.7 ± 1.1 | 47.4 ± 2.0 |

^{a}Percent of total bulk soil dry weight accounted for by the clay or silt size fractions; in addition to silt and clay, Shovelers Sink soil also contains 1% sand.
^{b}Minerals were identified by TEM and XRD analyses and are listed in decreasing order based on their detected content in corresponding size fractions.
^{c}Percent of the total Fe content of bulk soil accounted for by the clay or silt size fractions.

Both Fe(III)-reducing and Fe(II)-oxidizing microorganisms were detected in MPN enumerations conducted with soil samples from near the water table in 2007 and 2009 (Table 2). The abundance of Fe cycling organisms was, however, modest compared to total culturable aerobic heterotrophs. Analogous results have been reported for groundwater seep environments supporting active Fe redox cycling (Blothe and Roden, 2009) (Percak-Dennett and McBeth, 2011). In general these results suggest that the reductive (i.e. organotrophic) side of the microbial Fe redox cycle is likely to be driven by metabolism of the same plant-derived organic materials that presumably constitute in situ substrates for the much larger populations of aerobic heterotrophic bacteria.

TABLE 2
Most Probable Number (MPN) analysis of microorganisms
in Shovelers Sink soil collected in the vicinity of
water table in July 2007 and September 2009.

MPN (cells/g wet soil)

| Microbial group | July 2007 | September 2009 |
|---|---|---|
| Aerobic heterotrophs | 1.1 × 10⁶ | 4.2 × 10⁵ |
| O₂-dependent Fe(II) oxidizers | 2.9 × 10² | 2.4 × 10³ |
| Fe(III)-reducers | 2.4 × 10¹ | 2.3 × 10⁰ |

### Example 3

### Microbial Isolates

Fe(II)-oxidizing organisms were isolated from (1) soil samples collected in July 2007, June 2008, and September 2009, and (2) the highest positive dilutions from MPN studies set up in 2007 and 2009. Biotite was utilized as a solid phase form of Fe(II) for these studies. Unlike reduced smectite, structural Fe(II) in biotite is not subject to spontaneous reaction with O₂, thus permitting the use of O₂ as the electron acceptor for lithotrophic Fe(II) oxidation. Recent studies have demonstrated that the Fe(II)-oxidizing, NO₃⁻ reducing culture described by Straub et al. (Straub et al., 1996) can utilize Fe(II) in biotite as a sole electron donor for chemolithotrophic growth (Shelobolina and Xu, 2011). Samples and last positive MPN dilution cultures were serially diluted in biotite-containing roll-tubes. After solidification 3 ml of filter sterilized air were added to the headspace. Roll-tubes were incubated vertically at 20-22° C. (room temperature). Over a period of 4-8 months, small (0.2-0.5 mm) orange or red colonies formed between the layer of biotite and the layer of agarized medium in a roll-tube (FIG. 6). Each colony was transferred to 2 ml liquid medium with biotite provided as the electron donor and O₂ as the electron acceptor. A 4 years long isolation effort (2007 -2010) resulted in recovery of 73 biotite oxidizing cultures, which were maintained on liquid medium with biotite and O₂. Eleven cultures capable of oxidizing at least 5% of the structural Fe(II) content in biotite were selected for further study. Culture subsamples were streaked onto aerobic, low carbon medium culture plates. The resulting isolated colonies could be either mixotrophic Fe(II)-oxidizing microorganisms or heterotrophic contaminants. The numerically dominant colony types were tested for microaerophilic growth with FeCl₂ as a soluble Fe(II) source. Cultures capable of growing to a density of at least 10⁸ cells/ml with a total of about 8 mM FeCl₂ added over time were identified by 16S rRNA gene sequencing and selected for further study. The isolates so obtained included strains of Bradyrhizobium japonicum, Ralstonia solanacearum, and Cupriavidus necator. One strain each was chosen for further study (Table 3). Each of the cultures oxidized 3-4% of structural Fe(II) in biotite with O₂ as the electron acceptor, and each was found to be capable of oxidizing chemically-reduced smectite with NO₃⁻ as the electron acceptor (data not shown).

TABLE 3
Fe redox cycling microorganisms isolated from Shovelers
Sink soil. The % values indicate the degree of
similarity in 16S rRNA gene sequence.

| | GenBank | Identification | |
|---|---|---|---|
| | accession | (closest cultured | Role in |
| Strain | # | bacterium, % identity) | Fe cycle |
| wssl4 | JQ655459 | Bradyrhizobium liaoningense | Fe(II) |
| | | 2281^{T}, 99.6% | oxidation |
| | | Bradyrhizobium japonicum | |
| | | USDA 6^{T}, 99.4% | |
| ss1-6-6 | JQ655461 | Cupriavidus necator | Fe(II) |
| | | ATCC 43291^{T}, 99.5% | oxidation |
| | | “Ralstonia eutropha” | |
| | | H16, 99.6% | |
| in4ss52 | JQ655458 | Ralstonia solanacearum | Fe(II) |
| | | LMG 2299^{T}, 98.7% | oxidation |
| sa2 | JQ655460 | Geobacter toluenoxydans | Fe(III) |
| | | TMJ1^{T}, 98.9% | reduction |
| | | Geobacter uraniireducens | |
| | | RF4^{T}, 97.6% | |

Ferruginous NAu-2 smectite and hydrous ferric oxide (HFO) were used to enrich Fe(III)-reducing microorganisms from Shovelers Sink soil collected in July 2007 with acetate and H₂ as combined electron donors. Acetate and H₂ were used as these represent the two major sources of electron donor for microbial Fe(III) reduction in anoxic soils and sediments (Lovley et al., 2004). After about two months of room temperature incubation, small (25 clones each) 16S rRNA gene clone libraries were constructed from 1% enrichment cultures. Both enrichment cultures were dominated by an operational taxonomic unit (OTU) 99% similar to Geobacter toluenoxydans. G. toluenoxydans strain sa2 was recovered using the roll-tube method with acetate as the electron donor and fumarate as the electron acceptor. Like a type strain of this species, strain sa2 conserves energy from dissimilatory Fe(III) reduction concomitant with acetate oxidation using a variety of solid phase Fe(III) sources, including Fe(III) hydroxide and ferruginous smectite, but does not utilize nitrate as the electron acceptor.

### Example 4

### Microbial Redox Cycling of Fe in Clay Fraction of Samples

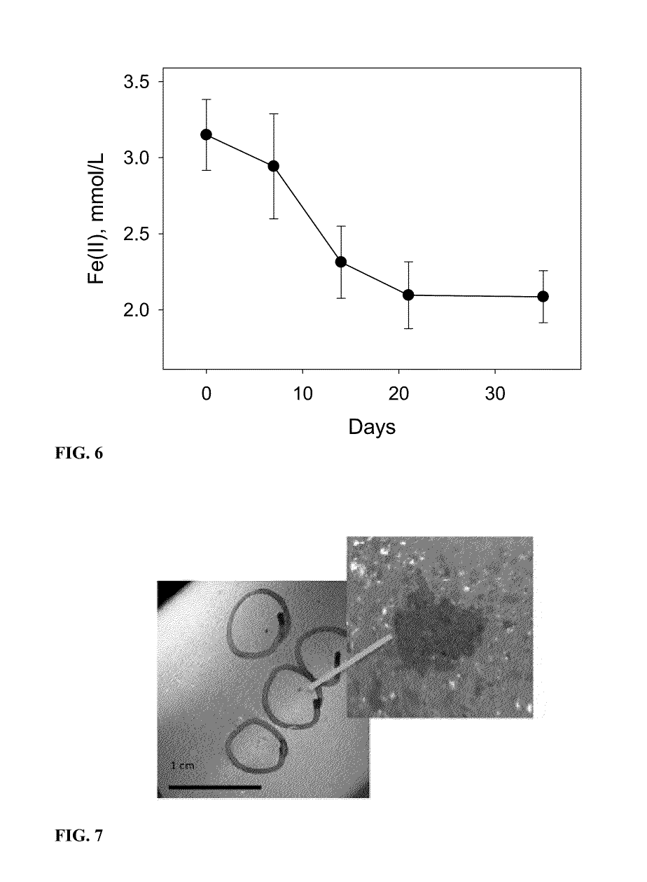

A Fe redox cycling experiment was conducted with clay size materials isolated from Shovelers Sink soil collected from about 65 cm depth in July 2007 (see Table 1). Although O₂ is a likely electron acceptor for microbial Fe(II) oxidation at Shovelers Sink (see above), NO₃⁻ was utilized in this model experiment since it does not react spontaneously with phyllosilicate-associated Fe(II). G. toluenoxydans strain sa2 (5% vol/vol inoculum from a culture grown previously for three transfers on limiting acetate/Shovelers Sink clay medium, providing about 10⁶ cells/ml) reduced 2.1 mmol/1 Fe(II) over 7 days (FIG. 7A). A small increase in aqueous Fe concentration was detected in both abiotic control and the Fe(III)-reducing cultures (35.4 μM and 50.6 μM, respectively). The source of dissolved Fe cannot be determined with available data. Although illite-smectite is the main Fe-bearing mineral controlling Fe biogeochemistry in Shovelers Sink soil, the clay size fraction is nevertheless a mixture of minerals, some of which could contain sorbed Fe(II) or small amounts of Fe(III) hydroxide coatings.

After 10 days, an inoculum of each of the three Fe(II)-oxidizing isolates (Table 3) were added to replicate microbially-reduced clay suspensions. The Fe(II)-oxidizing inocula (1-5% vol/vol) were grown heterotrophically on organics-limited NO₃⁻-reducing medium until the optical density at 600 nm of the culture stabilized, at which point all organic carbon had presumably been utilized. The inoculum volume was adjusted to provide about 10⁶ cells/ml. The cultures reoxidized 60-65% (about 1.2 mmol/l) of the Fe(II) generated by G. toluenoxydans strain sa2 (FIG. 7A) while consuming 0.82-1.15 mM NO₃⁻ (FIG. 7B). The incomplete reversibility of structural Fe redox cycle has been observed before (Shen and Stucki, 1994) and a possible explanation for this phenomenon is that the collapsing of smectite layers as the result of the Fe(III) reduction reaction makes a portion of the structural Fe(II) inaccessible (Stucki, 2011).

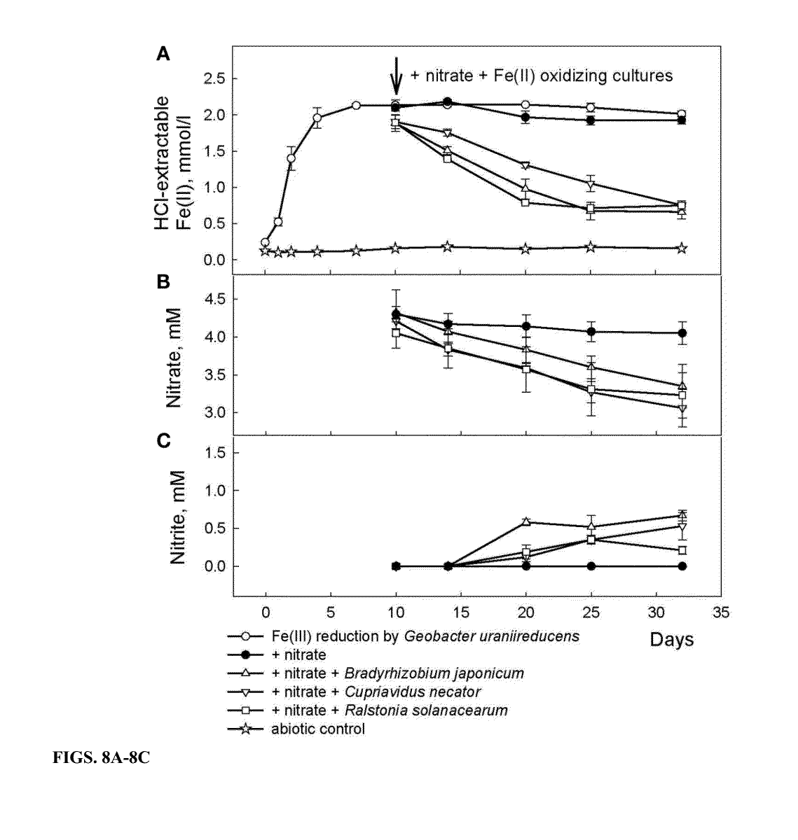

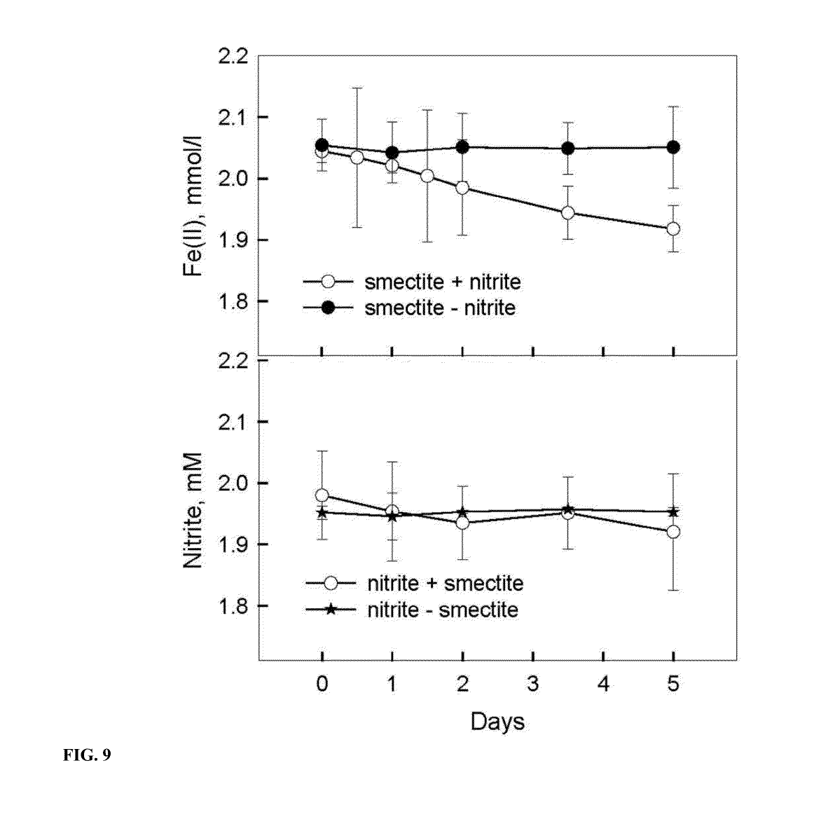

No Fe(II) oxidation or NO₃⁻ consumption took place in the absence of Fe(II)-oxidizing organisms. Although all of the Fe(II)-oxidizing isolates are denitrifying bacteria, substantial amounts of NO₂⁻ (0.35-0.67 mM) were produced during Fe(II) oxidation (FIG. 7C). Since the Shovelers Sink soil used in the Fe cycling experiment contained 1-2% associated organic carbon (see FIG. 2), NO₂⁻ produced during organotrophic oxidation of the associated organic carbon could have reacted chemically (abiotically) with Fe(II) in the reduced clay, thereby contributing to the Fe(II) oxidation activity shown in FIG. 7A. We deemed this pathway unlikely, given that each of the isolated strains reduced nitrate directly to N₂ with no significant NO₂⁻ accumulation in organotrophic medium (data not shown). Nevertheless, the extent to which reaction of Fe(II) with NO₂⁻ may have been responsible for the observed Fe(II) oxidation was evaluated in a separate experiment. Nitrite (2 mM) was added to a suspension of microbially-reduced Shovelers Sink clay, and the concentrations of Fe(II) and NO₂⁻ were followed over time (FIG. 8). The rate of chemical Fe(II) oxidation by nitrite (about 0.018 mmol/l/d; FIG. 8A) was 3-6 times less than the rate of oxidation in the microbial Fe cycling experiment (0.058-0.118 mmol/l/d; FIG. 7A). This result indicates that enzymatic activity was primarily responsible for nitrate-dependent oxidation of reduced Shovelers Sink clay. Similar conclusions were reached in a prior study of microbial nitrate-dependent oxidation of other types of solid-phase Fe(II) compounds in which significant accumulation of NO₂ took place (Weber et al., 2001). Thus, although the organic matter associated with Shovelers Sink clay brings uncertainty into the exact stoichiometry of Fe/N interactions, the results of this experiment confirm that Fe in the native Shovelers Sink clay is readily available for microbial redox transformation and can be cycled by the Fe(III)-reducing and Fe(II)-oxidizing microorganisms recovered from the soil.

### Example 5

### Iron and Potassium Can Be Released From Phyllosilicates by Microorganisms that Oxidize Phyllosilicate-Fe(II)

When Bradyrhizobium sp strain wss14 oxidized Fe(II) in the clay size fraction from Shovelers Sink soil, about 4.6 mg K and 0.4 mg Fe were released per 100 g clay.

### Example 6

### Free-Living Fe(II)-Oxidizing Microorganisms Improve K Availability to Plants (Prophetic)

It is contemplated that free-living Fe(II)-oxidizing rhizobial isolates described herein can be used as a commercial fertilizer replacement to improve K availability to plants. Rhizobia, such as Bradyrhizobium, have long been used to improve nitrogen availability to plants. Exemplary, non-limiting, conditions are provided below.

Two types of microbial inoculants can be used: seed-applied and soil-applied. The soil-applied inoculate may be easier to apply than the seed-applied inoculate, but it is more expensive on a per acre basis. For seed-applied inoculants (1) bacteria can be grown on a nutrient broth, (2) seeds can be inoculated with the grown culture so that each seed has 10³-10⁸ colony forming units (CFU) of the microorganism (exact number depends on kind and size of the seed), (3) seeds can be dried and (4) the seeds can be applied to the soil. Seed-applied inoculants are more effective when mixed with water to form a slurry that coats the seed. This should be done as close to planting time as possible, preferably within several hours. For soil-applied microbial inoculation, (1) bacteria can be grown on a nutrient broth to produce a microbial culture; (2) the microbial culture can be mixed with a carrier such as peat moss to obtain an inoculant having 10⁷-10⁹ CFU/gram carrier (carrier can be granulated afterwards), and (3) the inoculant can be applied to the soil at 8-40 kg/ha. For additional information about preparation of inoculants, see, e.g., Soybean Seed Applied Inoculation, Michigan State University Extension, Soybean Management and Research Technology (June, 2011), from which some of the described information was obtained.

The invention has been described in connection with what are presently considered to be the most practical and preferred embodiments. However, the present invention has been presented by way of illustration and is not intended to be limited to the disclosed embodiments. Accordingly, those skilled in the art will realize that the invention is intended to encompass all modifications and alternative arrangements within the spirit and scope of the invention as set forth in the appended claims.

The invention claimed is:

1. A composition comprising at least one isolated microorganism that oxidizes Fe(II) in a primary phyllosilicate and a carrier.

2. The composition of claim 3, wherein the at least one microorganism is selected from the group consisting of a Bradyrhizobium japonicum strain, a Ralstonia solanacearum strain, a Cupriavidus necator strain, a Dechloromonas agitate strain, and a Nocardioides strain.
